(19) United States
(12) Patent Application Publication
(10) Pub. No.: US 2018/0047310 A1
(43) Pub. Date: Feb. 15, 2018

(54) Digital Product Display Tag and Method of Use Thereof

(71) Applicants: Clara Toney, Madison, AL (US); Patrice Simmons, Huntsville, AL (US)

(72) Inventors: Clara Toney, Madison, AL (US); Patrice Simmons, Huntsville, AL (US)

(21) Appl. No.: 15/675,673

(22) Filed: Aug. 11, 2017

Related U.S. Application Data
(60) Provisional application No. 62/373,481, filed on Aug. 11, 2016.

(51) Int. Cl. G09F 3/20

(52) U.S. Cl. CPC G09F 3/208; G09F 3/203; G09G 2380/04; G09G 2370/16

(57) ABSTRACT

A digital product display tag allows a user to dynamically change information displayed on a digital display about the product the display tag is attached to. A user may interact with a user interface on a computing device in order to wirelessly change information displayed on the product display tag, saving time and effort to physically re-do and replace any tags which require a change of displayed information.

The current application claims a priority to the U.S. Provisional Patent application Ser. No. 62/373,481 filed on Aug. 11, 2016.

### FIELD OF THE INVENTION

The present invention relates generally to product display. More particularly, the present invention relates to a device that digitally displays information about a particular product such as an automobile that can be changed electronically and wirelessly.

### BACKGROUND OF THE INVENTION

A motor vehicle is a self-propelled road vehicle or off-road vehicle, commonly wheeled, that does not operate on rails, such as trains or trams and used for the transportation of passengers, or passengers and property.

Propulsion for motor vehicles is provided by an engine or motor, usually by an internal combustion engine, or an electric motor, or some combination of the two, such as hybrid electric vehicles and plug-in hybrids. For legal purposes motor vehicles are often identified within a number of vehicle classes including cars, buses, motorcycles, off-road vehicles, light trucks and regular trucks. These classifications vary according to the legal codes of each country. ISO 3833:1977 is the standard for road vehicles types, terms and definitions.

As of 2010 there were more than one billion motor vehicles in use in the world, excluding off-road vehicles and heavy construction equipment. Global vehicle ownership per capita in 2010 was 148 vehicles in operation per 1000 people. The United States has the largest fleet of motor vehicles in the world, with 239.8 million in 2010. Vehicle ownership per capita in the US is also the highest in the world with 769 vehicles in operation per 1000 people. The People's Republic of China has the second largest fleet in the world, with slightly more than 78 million vehicles and since 2009 became the world's largest new car market. In 2011, a total of 80 million cars and commercial vehicles were built, led by China, with 18.4 million motor vehicles manufactured.

Sales is an important part of the automotive industry, as a large portion of residents of the United States, Europe and many other countries around the world own one or more automobiles that they use for many purposes such as commuting to work, shopping, and other purposes. One ubiquitous means of selling cars is a car dealership, or local vehicle distribution business which sells new or used cars at the retail level, based on a dealership contract with an automaker or its sales subsidiary. A car dealership employs automotive salespeople to sell their vehicles to customers.

Typically, each car on an automotive sales lot has a hanging tag that displays information about that particular vehicle such as, but not limited to, the asking price of the vehicle, the Kelley Blue Book price based on vehicle valuation and automotive research, and more. These tags are typically handwritten and hung on the rearview mirror of the specific car. These handwritten tags must be physically hung in each car by an employee of the dealership. Sale prices for vehicles are changed as needed, which is often daily due to price fluctuations and other factors. Changes must be handwritten on a new hangtag and physically replaced in said vehicle. The effort required to keep hangtags current and accurate requires a great deal of redundancy and time. The present invention seeks to solve the aforementioned problems by presenting an electronic tag that displays information that can be changed over a wireless network.

### BRIEF DESCRIPTION OF THE DRAWINGS

FIG. 1 is a front view of one embodiment of the present invention.

FIG. 2 is a perspective view of one embodiment of the present invention with the hanger hook shown in an exploded configuration.

FIG. 3 is a schematic system diagram of one embodiment of the present invention.

FIG. 4 is a stepwise flow diagram describing the general method of the present invention.

FIG. 5 is a stepwise flow diagram describing steps for selecting attributes to display on the digital display.

FIG. 6 is a stepwise flow diagram describing steps for displaying different attribute types in corresponding display areas.

FIG. 7 is a stepwise flow diagram describing steps for replacing a displayed attribute with a new attribute.

FIG. 8 is a stepwise flow diagram describing steps for validating user credentials to allow modification of displayed attributes.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced or utilized without the implementation of some features as they are described. It should be understood that some details have not been described in detail in order to not unnecessarily obscure focus of the invention.

The present invention is a digital product display tag and method of use thereof. In particular, the present invention may be utilized in one preferred embodiment of the invention to digitally display prices and other information for vehicles on display for sale in an automotive sales lot. The present invention allows displayed information for the vehicles to be changed without requiring manually walking to the vehicle and replacing the sales tag due to a change such as a price change. The information displayed on the present invention can be changed using computer software designed to allow car dealerships to quickly make updates to the information displayed for each vehicle.

As a summary of the one preferred embodiment, the present invention is a rectangular LED device with a receiver that has the ability for each car dealership to display customized information by using letters, numbers, and symbols. The present invention further has a retractable hook that allows the device to be hung securely on the rearview mirror of a car. The device is solar-powered and battery-operated. It is a wireless device that is computer operated. In some uses, the present invention may be referred to as an automotive eTag. In some embodiments, the present invention may be understood to be a system.

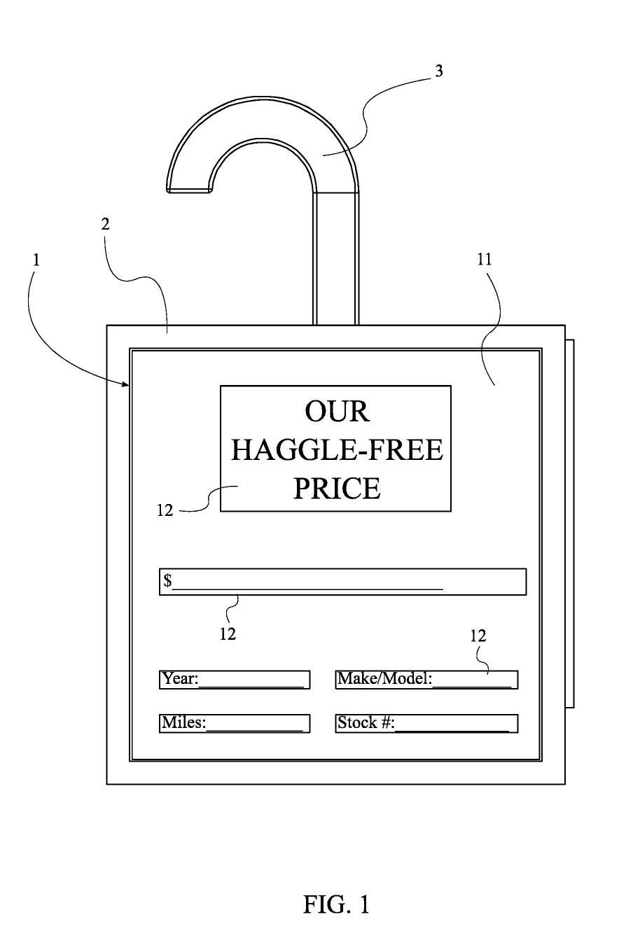

Referring to FIGS. 1-3, in general, the apparatus of the present invention comprises a digital display 1, a housing 2, a hanger hook 3, a power source 4, a processor 5, and a wireless communication device 6. Generally, the digital display 1 and the hanger hook 3 are connected to the housing 2. The power source 4 is electrically connected to the digital display 1, the processor 5, and the wireless communication device 6. Furthermore, the processor 5 is electronically connected to the digital display 1 and the wireless communication device 6. The processor 5 may be any type of electronic component that facilitates receiving, processing, and sending electronic information and commands to and from other electronic components, such as, but not limited to, a microchip, a microprocessor 5, a central processing unit (CPU), a printed circuit board (PCB) with logic components, a system on a chip, an integrated circuit (IC), or any other combination of electronic components which allow the present invention to function as intended.

Furthermore, the wireless communication device 6 may be any electronic device that facilitates electronic communication with other electronic devices through wireless radio frequency (RF) means or other wireless communication means, such as IEEE 802.11 standards, that enable communication with a local area network (LAN), other wireless communication-capable devices, or the like. In some embodiments, the power source 4, the processor 5, and the wireless communication device 6 are positioned within the housing 2. In some embodiments, one or all of the power source 4, the processor 5, and the wireless communication device 6 are positioned external to the housing 2.

In the preferred embodiment, the wireless communication device 6 is configured and utilized to communicate from an administrator computer terminal or other device in order to control the content displayed on the digital display 1 device. For example, being able to wirelessly control content displayed on the digital display 1 device allows a user 106 to change sale prices, make, model, year or other information on an instance of the present invention displayed on a vehicle in an automotive sales lot without necessitating physically replacing a sales tag on each vehicle. In automotive sales lots with many vehicles for sale, this aspect can greatly reduce time and effort needed to modify sales information displayed on the vehicles.

In some embodiments, the present invention may further comprise a data cable connection 7, allowing the user 106 to manually access the present invention with a separate external control device upon connecting said devices. This is not ideal for the intent of the present invention, however, since the user 106 must again physically travel to the device to change displayed information. However, it may also be a useful feature in case the device necessitates repair, and/or the wireless communication device 6 is inoperable or inaccessible. Preferably, the data cable connection 7 traverses into the housing 2. It is contemplated that any alternative arrangements may be comprised in the present invention in order to fulfill the intended functionality of the data cable connection 7. The data cable connection 7 is electronically connected to the processor 5. The data cable connection 7 may comprise any relevant and/or useful standard of data transfer, such as, but not limited to, a Serial ATA (SATA) connection, a high definition multimedia interface (HDMI) connection, a universal serial bus (USB) connection, or the like.

The digital display 1 is one of the primary focuses of the present invention. The digital display 1 may be a light-emitting diode (LED) electronic display screen, or any other relevant type of electronic display screen which is capable of displaying messages based on computer instructions. In some embodiments, the digital display 1 is externally connected to the housing 2. In some embodiments, the digital display 1 may be positioned within a recess of the housing 2, such that the digital display 1 rests flush with the side of the housing 2. In some embodiments, the digital display 1 traverses into the housing 2 in such a manner that the digital display 1 is held in place, surrounded by portions of the housing 2, while a portion of the digital display 1 is positioned within the boundaries of the housing 2. In any embodiment, the digital display 1 should be positioned and connected with respect to the housing 2 such that the digital display 1 is connected to and supported by the housing 2, while at the same time the digital display 1 is exposed for viewing and not obstructed from view by the housing 2. In some embodiments, the digital display 1 is configured to display a single piece of information, such as, but not limited to, price.

In some embodiments, the digital display 1 is configured with multiple display areas, each assigned to a display a particular attribute of the product, such as, but not limited to, price, year of vehicle, make of vehicle, model of vehicle, current mileage of the vehicle, stock number, business slogan, custom text, or other information. As such, in some embodiments, the digital display 1 may comprise a primary display area 11 and a plurality of secondary display areas 12, as illustrated in FIG. 1. The primary display area 11 may be understood herein to represent the total area or boundary of the digital display 1 capable of displaying programmable information. The plurality of secondary displays is distributed around the primary display area 11, and may each be configured to display a specific category of attribute or other information, or each may be customizably programmed to display any desired information, such as, but not limited to, images, videos, or any other relevant visual media.

The housing 2 may be any structural component which is capable of holding and supporting the rest of the components of the present invention. The housing 2 may be made of any applicable material, such as, but not limited to, plastics materials such as polyvinyl chloride (PVC), thermoplastic, high-density polyethylene (HDPE), metals such as steel, brass, titanium, lead, tin, or other allows or metals, or any other rigid or elastic materials.

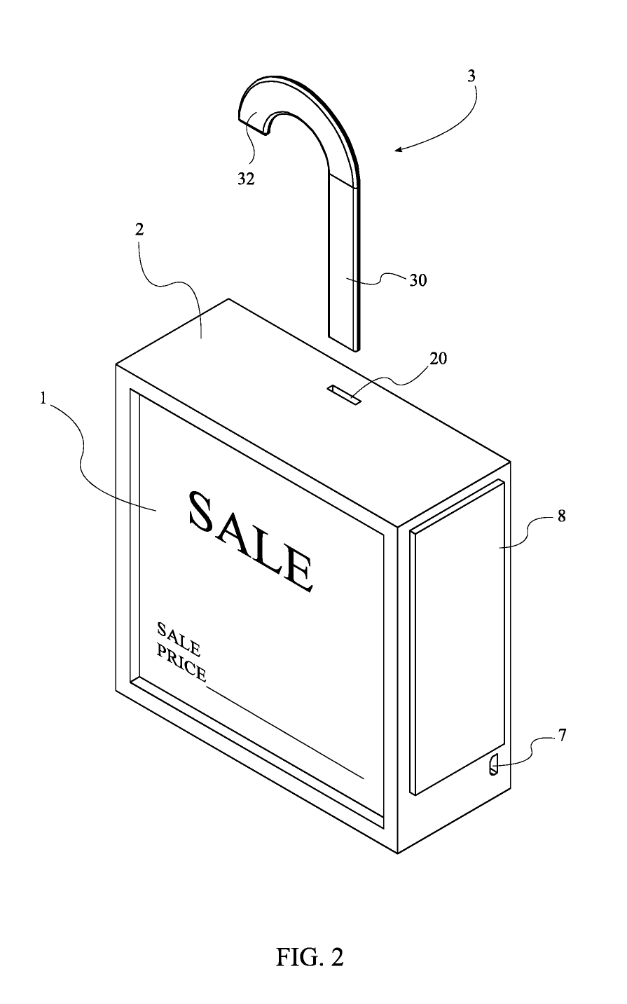

The hanger hook 3 allows the present invention to be hung from the rear-view mirror of a vehicle, or on another applicable location. It should be understood that the present invention should not be restricted to applications in motor vehicles, and may be utilized in many other applications. In some embodiments, the hanger hook 3 traverses into the housing 2. In some embodiments, the hanger hook 3 is permanently fixed to the housing 2. In some embodiments, the hanger hook 3 traverses into the housing 2. In some embodiments, the hanger hook 3 is retractably connected to the housing 2. More particularly, in some embodiments, the present invention may further comprise a slot 20 traversing into the housing 2, with the hanger hook 3 furthermore comprising a shaft portion 30 and a hook portion 32, and the shaft portion 30 being slidably positioned within the slot 20, as illustrated in FIG. 2. The hook portion 32 is connected adjacent to the shaft portion 30 opposite the housing 2.

The hanger hook 3 may be considered optional, and may not be comprised in all embodiments. Not every car dealership uses hangtags, and new cars may have window stickers that are placed in the window at the factory that lists the feature of the car. In lieu of hanging a device from the rear-view mirror of a vehicle, an auto dealership may simply place the device inside the vehicle against a window for ease of viewing, or in another suitable location. For example, an instance of the present invention may be placed inside a sleeve that is attached to one of the windows of the vehicle.

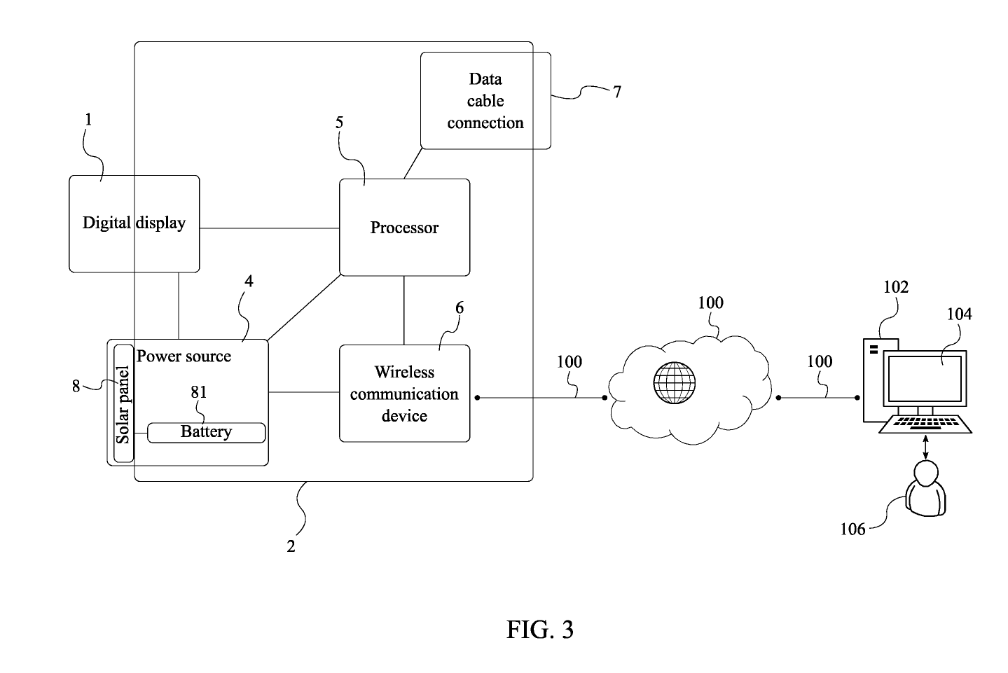

It is contemplated that in various embodiments of the present invention, the power source 4 may comprise any type of electrical power that allows the present invention to function as intended. However, in reference to FIGS. 2-3, in one preferred embodiment of the present invention, the power source 4 comprises a solar panel 8 and a battery 81, with the solar panel 8 being electrically connected to the battery 81. This allows the digital product display tag to retain enough power to function at all hours throughout the day.

Furthermore, in some embodiments, a newly created computer program allows for information to be transmitted from a computer to a specific device. The program should require that the operator have administrative rights in order to access the information and should be password protected. The program should include dropdown menus specific to models of automobiles that would facilitate quicker operations. These menus may include, but are not limited to, such things as make, model, and year.

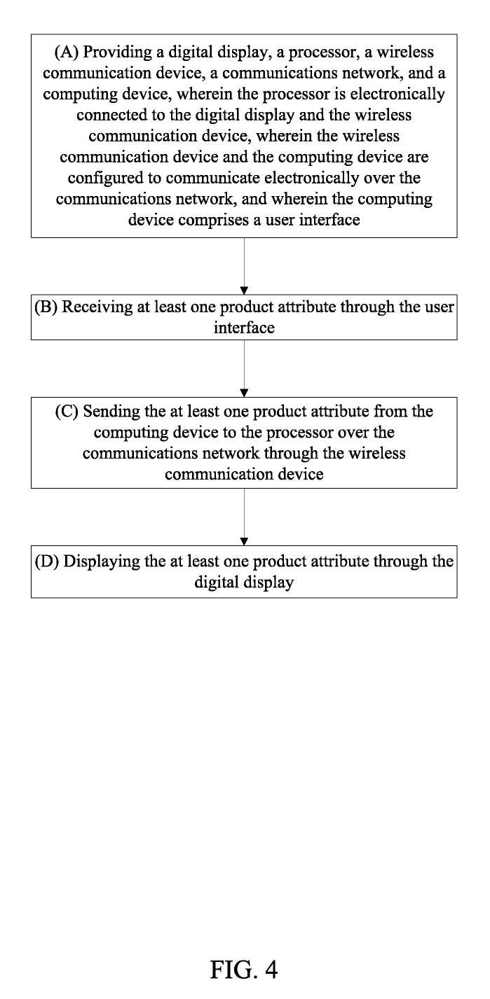

In reference to FIGS. 3-4, in the method of use of the digital product display tag, a digital display 1, a processor 5, a wireless communication device 6, a communications network 100, and a computing device 102 are provided. As disclosed, the processor 5 is electronically connected to the digital display 1 and the wireless communication device 6. The wireless communication device 6 and the computing device 102 are configured to communicate electronically over the communications network 100, and the computing device 102 comprises a user interface 104. In general, at least one product attribute is received through the user interface 104. This step in the method represents the user 106 inputting one or more values or other attributes into the user interface 104 of the computing device 102 that is desired to display on the digital display 1. The at least one product attribute is then sent from the computing device 102 to the processor 5 over the communications network 100 and through the wireless communication device 6. The at least one product attribute is displayed through the digital display 1.

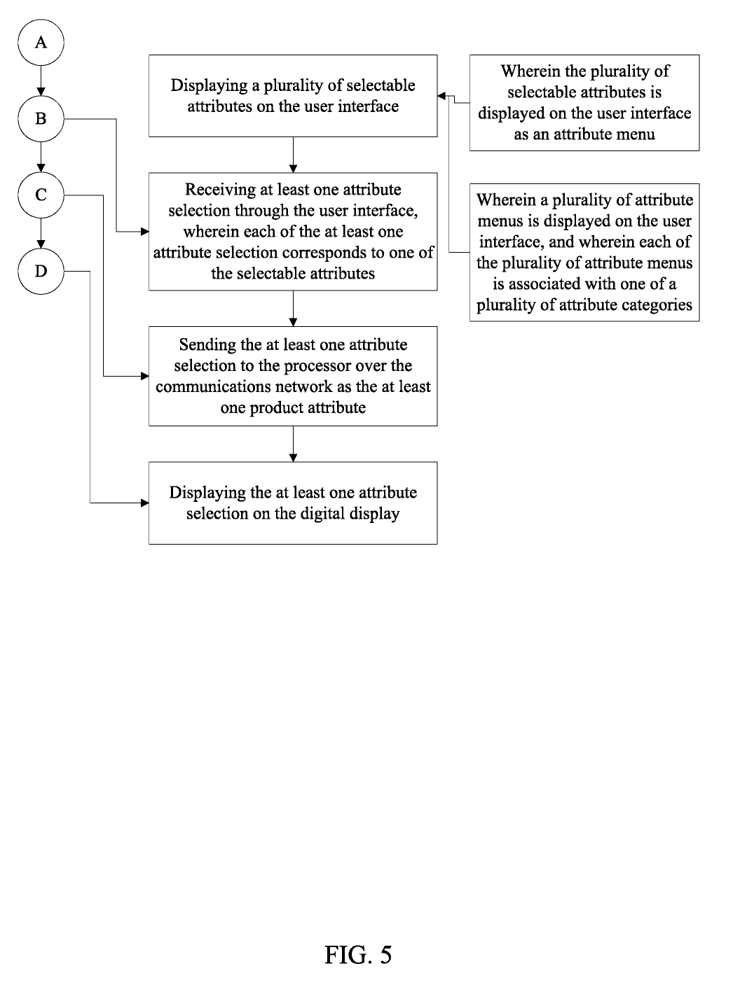

In some embodiments, a plurality of selectable attributed may be displayed on the user interface 104 for the user 106 to choose from. Referring to FIG. 5, at least one attribute selection may be received through the user interface 104, wherein each of the at least one attribute selection corresponds to one of the selectable attributes. Then the at least one attribute selection is sent to the processor 5 over the communications network 100 as the at least one product attribute, and the at least one attribute selection is displayed on the digital display 1.

In some embodiments, the plurality of selectable attributes is displayed on the user interface 104 as an attribute menu, such as, but not limited to, a drop-down menu. In some embodiments, multiple drop-down menus may be displayed to the user 106 for selection. Thus, a plurality of attribute menus may be displayed on the user interface 104, with each of the plurality of attribute menus being associated with one of a plurality of attribute categories.

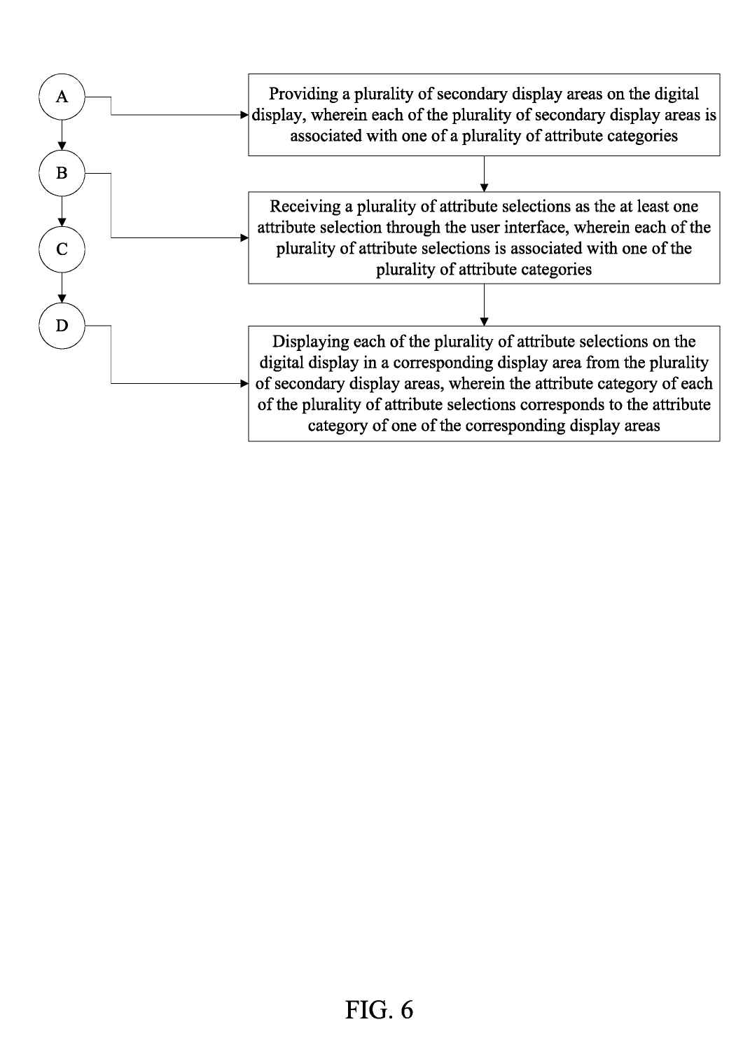

Referring to FIG. 6, in some embodiments, a plurality of secondary display areas 12 is provided on the digital display 1, wherein each of the plurality of secondary display areas 12 is associated with one of a plurality of attribute categories. A plurality of attribute selections may then be received as the at least one attribute selection through the user interface 104, wherein each of the plurality of attribute selections is associated with one of the plurality of attribute categories. Subsequently, each of the plurality of attribute selections is displayed on the digital display 1 in a corresponding display area from the plurality of secondary display areas 12, wherein the attribute category of each of the plurality of attribute selections corresponds to the attribute category of one of the corresponding display areas of the plurality of secondary display areas 12.

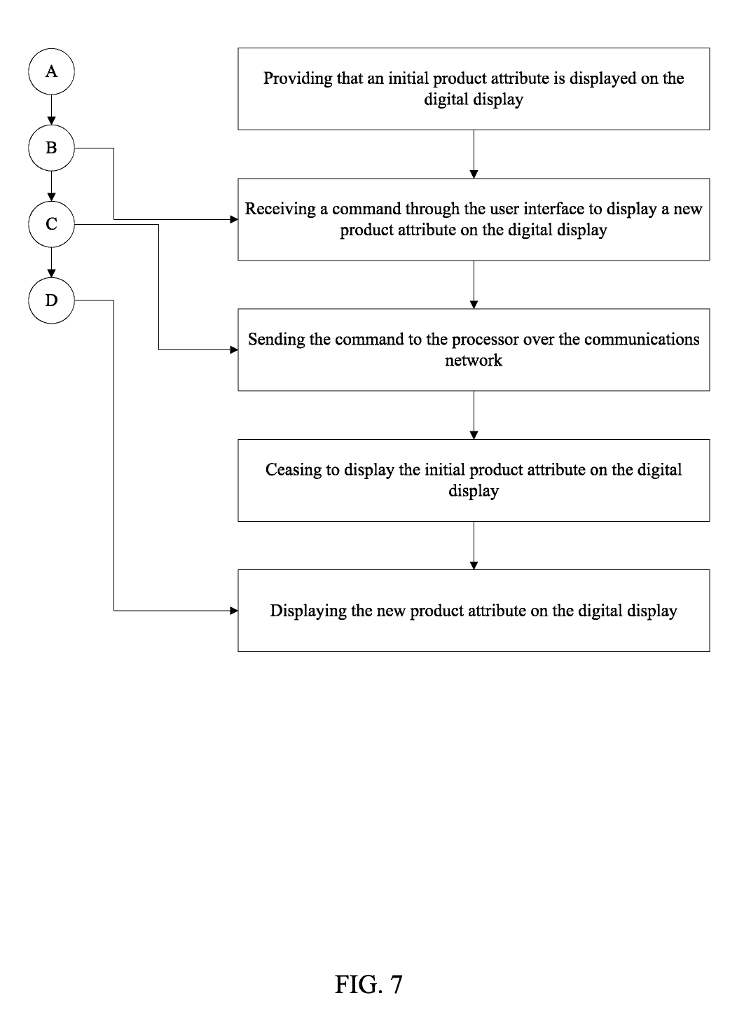

A user 106 of the present invention may desire to change one or more product attributes or other information displayed on the digital display 1. Thus, referring to FIG. 7, providing that an initial product attribute is displayed on the digital display 1, a command may be received through the user interface 104 to display a new product attribute on the digital display 1. Said command is then sent to the processor 5 over the communications network 100, as previously discussed. Subsequently, the initial product attribute is ceased to display on the digital display 1, and the new product attribute is displayed on the digital display 1.

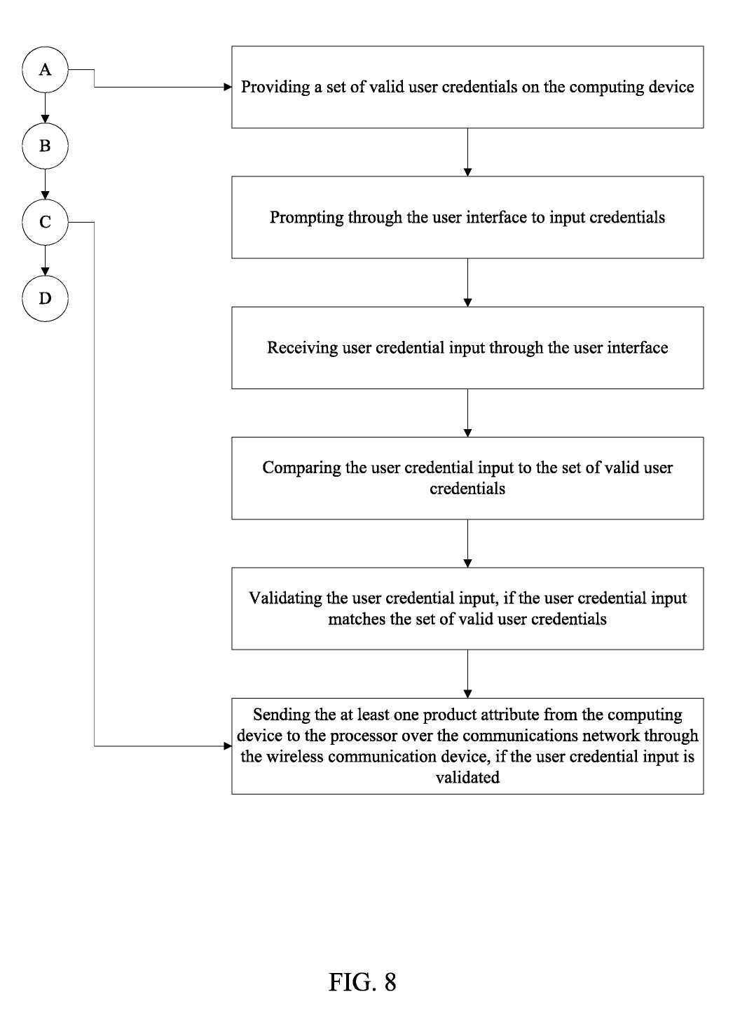

In some embodiments, in order for a user 106 to utilize the present invention to change information displayed on the digital display 1, authorized user 106 credentials must be entered into the user interface 104 in order to access the software for utilizing the present invention. Thus, referring to FIG. 8, a set of valid user 106 credentials is provided on the computing device 102, on a networked server, on a cloud computer, or in another location accessible to the computing device 102. Before the user 106 can access the software of the user interface 104, the user 106 is prompted through the user interface 104 to input credentials. Subsequently, user 106 credential input may be received through the user interface 104. The user 106 credential input is then compared to the set of valid user 106 credentials. The user 106 credential input is then validated if the user 106 credential input matches the set of valid user 106 credentials. Subsequently, the user 106 may perform the aforementioned tasks for managing the digital display 1. Thus, the at least one product attribute is sent from the computing device 102 to the processor 5 over the communications network 100 through the wireless communication device 6 only if the user 106 credential input is validated.

Although the invention has been explained in relation to its preferred embodiment, it is to be understood that many other possible modifications and variations can be made without departing from the spirit and scope of the invention as hereinafter claimed.

What is claimed is:

1. A digital product display tag comprises:
a digital display;
a housing;
a power source;
a processor;
a wireless communication device;
the digital display being connected to the housing;
the power source being electrically connected to the digital display, the processor, and the wireless communication device; and
the processor being electronically connected to the digital display and the wireless communication device.

2. The digital product display tag as claimed in claim 1 comprises:
the power source, the processor, and the wireless communication device being positioned within the housing.

3. The digital product display tag as claimed in claim 1 comprises:
the power source comprises a solar panel and a battery; and
the solar panel being electrically connected to the battery.

4. The digital product display tag as claimed in claim 1 comprises:
a data cable connection;
the data cable connection traversing into the housing; and
the data cable connection being electronically connected to the processor.

5. The digital product display tag as claimed in claim 1 comprises:
the digital display traversing into the housing.

6. The digital product display tag as claimed in claim 1 comprises:
the digital display comprises a primary display area and a plurality of secondary display areas; and
the plurality of secondary display areas being distributed around the primary display area.

7. The digital product display tag as claimed in claim 1 comprises:
a hanger hook; and
the hanger hook being connected to the housing.

8. The digital product display tag as claimed in claim 7 comprises:
the hanger hook traversing into the housing.

9. The digital product display tag as claimed in claim 7 comprises:
the hanger hook being retractably connected to the housing.

10. The digital product display tag as claimed in claim 7 comprises:
a slot traversing into the housing;
the hanger hook comprises a shaft portion and a hook portion; and
the shaft portion being slidably positioned within the slot.

11. A method of using a digital product display tag comprises the steps of:
providing a digital display, a processor, a wireless communication device, a communications network, and a computing device,
wherein the processor is electronically connected to the digital display and the wireless communication device,
wherein the wireless communication device and the computing device are configured to communicate electronically over the communications network, and
wherein the computing device comprises a user interface;
receiving at least one product attribute through the user interface;
sending the at least one product attribute from the computing device to the processor over the communications network through the wireless communication device; and
displaying the at least one product attribute through the digital display.

12. The method of using a digital product display tag as claimed in claim 11 comprises the steps of:
displaying a plurality of selectable attributes on the user interface;
receiving at least one attribute selection through the user interface, wherein each of the at least one attribute selection corresponds to one of the selectable attributes;
sending the at least one attribute selection to the processor over the communications network as the at least one product attribute; and
displaying the at least one attribute selection on the digital display.

13. The method of using a digital product display tag as claimed in claim 12, wherein the plurality of selectable attributes is displayed on the user interface as an attribute menu.

14. The method of using a digital product display tag as claimed in claim 13, wherein a plurality of attribute menus is displayed on the user interface, and wherein each of the plurality of attribute menus is associated with one of a plurality of attribute categories.

15. The method of using a digital product display tag as claimed in claim 11 comprises the steps of:
providing a plurality of secondary display areas on the digital display, wherein each of the plurality of secondary display areas is associated with one of a plurality of attribute categories;
receiving a plurality of attribute selections as the at least one attribute selection through the user interface, wherein each of the plurality of attribute selections is associated with one of the plurality of attribute categories; and
displaying each of the plurality of attribute selections on the digital display in a corresponding display area from the plurality of secondary display areas, wherein the attribute category of each of the plurality of attribute selections corresponds to the attribute category of one of the corresponding display areas.

16. The method of using a digital product display tag as claimed in claim 11 comprises the steps of:
providing that an initial product attribute is displayed on the digital display;
receiving a command through the user interface to display a new product attribute on the digital display;
sending the command to the processor over the communications network;
ceasing to display the initial product attribute on the digital display; and
displaying the new product attribute on the digital display.

17. The method of using a digital product display tag as claimed in claim 11 comprises the steps of:
providing a set of valid user credentials on the computing device;
prompting through the user interface to input credentials;
receiving user credential input through the user interface;
comparing the user credential input to the set of valid user credentials;
validating the user credential input, if the user credential input matches the set of valid user credentials; and
sending the at least one product attribute from the computing device to the processor over the communications network through the wireless communication device, if the user credential input is validated.
